(19) United States
(12) Patent Application Publication
(10) Pub. No.: US 2018/0248504 A1
(43) Pub. Date: Aug. 30, 2018

(54) BRUSH-LESS DC MOTOR CONTROL DEVICE, SYSTEM AND METHOD

(71) Applicant: INTERNATIONAL GREEN CHIP (TIANJIN) CO., LTD., Tianjin (CN)

(72) Inventors: Jianhui LIN, Tianjin (CN); Weixin ZHANG, Tianjin (CN); Weizheng XU, Tianjin (CN)

(73) Assignee: INTERNATIONAL GREEN CHIP (TIANJIN) CO., LTD., Tianjin (CN)

(21) Appl. No.: 15/485,769

(22) Filed: Apr. 12, 2017

(30) Foreign Application Priority Data
Feb. 24, 2017 (CN) 201710103802.9

(51) Int. Cl. H02P 21/00; H02P 6/16

(52) U.S. Cl. CPC H02P 21/0003; H02P 6/16

(57) ABSTRACT

A brush-less DC motor control device includes a position detecting unit that detects the position of a motor rotor and acquires the position signals of the rotor, a reference generating unit that selects a reference time moment according to the rotor's position signal, a current measuring unit that measures the phase current of the motor and acquires the phase current at the reference time moment according to the measured phase current, a calculation unit that calculates the direct axis current of the motor according to the acquired phase current, a phase adjusting unit that adjusts the phase of the drive voltage of a motor coil according to the difference value between the direct axis current of the motor and an expected target current, and a drive unit that outputs drive signals of the motor coil according to the acquired position signal and the phase of the coil's drive voltage.

### BACKGROUND OF THE INVENTION

### Technical Field

The present application relates to the motor control field, in particular to a brush-less DC motor control device, system and method.

### Description of Related Art

Replacing mechanical steering with electronic steering, a brush-less electromotor overcomes a series of problems related to a conventional DC motor generated due to friction from an electric brush, is advantageous in excellent speed regulation performance, has a small size and high efficiency, etc., and therefore is widely applied to various fields of the civil economy and the daily life of people.

Windings of the brush-less motor present inductance characteristics, so the phase current of the motor lags behind applied voltage. In order to fulfill the aims of efficiency optimization and high-speed operation, it needs to apply a certain lead angle onto the drive voltage. In some applications, the lead angle is usually calculated by an approximate estimation method.

Conventionally, the required advance angle is estimated by measuring variables, such as average current, peak current and speed, or controlling variables, and the configuration is optimized through gains or offsets at a target working point. Such algorithm has obvious limits: the control targets (for example efficiency optimization) are only achieved at specific working points, once the motor further deviates from the target working point, the running status of the motor further deviates from the target (for example low efficiency), and even raises dangers such as overspeed. The specific parameters of the optimized configuration are directly related to the main body parameters and load characteristics of the motor, resulting in failure to universally apply the control solution to various motors and loads. Thus, bad effects are generated on the reliability, consistency, batch production and material management of the motor system.

### SUMMARY OF THE INVENTION

The present application provides a brush-less DC motor control device, system and method. The device first selects a reference time moment, calculates the direct axis current of the motor at the reference time moment, and automatically adjusts the phase of the drive voltage of motor coils according to the relationship between the direct axis current and an expected target current to perform self-adaptive control over the brush-less DC motor under the condition of different load characteristics, thus improving the performance, reliability and consistency of the brush-less DC motor system and reducing difficulties in material management.

First, a brush-less DC motor control device is provided. The device comprises a position detecting unit, a reference generating unit, a current measuring unit, a calculation unit, a phase adjusting unit and a drive unit. The position detecting unit is used for detecting the position of a motor rotor and acquiring the position signals of the motor rotor. The reference generating unit is used for selecting a reference time moment according to the position signal of the motor rotor. The current measuring unit is used for measuring the phase current of the motor and acquiring the phase current at the reference time moment according to the phase current of the motor. The calculation unit is used for calculating the direct axis current of the motor according to the phase current at the reference time moment. The phase adjusting unit is used for adjusting the phase of the drive voltage of the motor coil according to the difference value between the direct axis current of the motor and an expected target current. The drive unit is used for outputting drive signals of the motor coil according to the position signal of the motor rotor and the phase of the drive voltage of the motor coil to push the motor rotor to rotate.

In an optional implementation mode, the position detecting unit includes one or more Hall components, and the Hall components are mutually spaced at a certain electric angle interval. The Hall components are used for detecting the position of the motor rotor and acquiring the position signal of the motor rotor according to the magnetic field of the motor rotor.

In an optional implementation mode, the reference generating unit is specifically used for selecting one or more reference time moments during an electrical cycle according to the position signal of the motor rotor.

In an optional implementation mode, the current measuring unit is specifically used for measuring the phase current at the reference moment according to the phase current of the motor to acquire the phase current at the reference moment.

In an optional implementation mode, the current measuring unit is specifically used for estimating the phase current at the reference time moment according to the measured value of the phase current of the motor during an electrical cycle to acquire the phase current of the reference time moment.

In an optional implementation mode, the direct axis current i_{d} is expressed in a way of i_{d}=A_{MP}[i_{U} cos(θ)+i_{V} cos(θ−2/3π)+i_{W} cos(θ+2/3π)], wherein i_{d} is the current along the direction of the direct axis in the rotating coordinate system which is synchronous to the motor rotor, i_{U}, i_{V} and i_{W} are respectively phase currents along the directions of the U axis, V axis and W axis in a static coordinate system which is formed by three phase currents; A_{MP} is a normalization coefficient for converting the static coordinate system formed by the three phase currents into the rotating coordinate system which is synchronous to the motor rotor; 2/3π is the included angle between every two of the phase currents of the U axis, V axis and W axis; and θ is the included angle between the U axis and the direct axis.

In an optional implementation mode, when the motor is a multi-phase motor, the phase adjusting unit uniformly adjusts the phase of each phase coil or respectively adjusts the phase of each phase coil, according to the difference value between the direct axis current of each phase coil and a corresponding expected target current.

In an optional implementation mode, the drive signal of the motor coil output by the drive unit is a pulse width modulation signal.

Second, a brush-less DC motor control system is provided. The system includes a motor control device, a power switch circuit and a brush-less DC motor. The motor control device includes the brush-less DC motor control device as described in the first aspect, which outputs control signals of the motor coils. The power switch circuit includes a power component, and controls the on or off of the power component according to the drive signal output by the brush-less DC motor control device and then outputs the drive voltage to the motor coils. The brush-less DC motor includes a motor rotor and by the effect of the drive voltage, pushes the motor rotor ro rotate.

Third, a brush-less DC motor control method is provided. The method comprises the following steps: detecting the position of the motor rotor and acquiring the position signal of the motor rotor; selecting the reference time moment according to the position signal of the motor rotor; measuring the phase current of the motor and acquiring the phase current at the reference time moment according to the phase current of the motor; calculating the direct axis current of the motor according to the phase current at the reference time moment; adjusting the phase of the drive voltage of each of the motor coils according to the difference value between the direct axis current of the motor and an expected target current; and outputting the drive signals of the motor coils according to the position signal of the motor rotor and the phase of the drive voltage of each of the motor coils to push the motor rotor to rotate.

In an optional implementation mode, the step of selecting the reference time moment according to the position signal of the motor rotor specifically includes selecting one or more reference time moments during an electrical cycle according to the position signal of the motor rotor.

In an optional implementation mode, the step of acquiring the phase current at the reference time moment according to the phase current of the motor specifically includes: measuring the phase current at the reference moment according to the phase current of the motor to acquire the phase current at the reference moment.

In an optional implementation mode, the step of acquiring the phase current at the reference time moment according to the phase current of the motor specifically includes: estimating the phase current at the reference moment according to the measured value of the phase current of the motor during an electrical cycle to acquire the phase current at the reference moment.

In an optional implementation mode, the direct axis current i_{d} is expressed in a way of i_{d}=A_{MP}[i_{U} cos(θ)+i_{V} cos(θ−2/3π)+i_{W} cos(θ+2/3π)], wherein i_{d} is the current along the direction of the direct axis in the rotating coordinate system which is synchronous to the motor rotor, i_{U}, i_{V} and i_{W} are respectively phase currents along the directions of the U axis, V axis and W axis in a static coordinate system which is formed by three phase currents; A_{MP} is a normalization coefficient for converting the static coordinate system formed by the three phase currents into the rotating coordinate system which is synchronous to the motor rotor; 2/3π is the included angle between every two of the phase currents of the U axis, V axis and W axis; and θ is the included angle between the U axis and the direct axis.

In an optional implementation mode, when the motor is a multi-phase motor, the method also includes a step of the uniformly adjusting the phase of each phase coil or respectively adjusting the phase of each phase, according to the difference value between the direct axis current of each phase coil and a corresponding expected target current.

In an optional implementation mode, the drive signal of the motor coil is a pulse width modulation signal.

### BRIEF DESCRIPTION OF THE SEVERAL VIEWS OF THE DRAWINGS

To more clearly describe the technical solution of the embodiments of the present invention, the following is simple introduction to the attached drawings used in the embodiments.

FIG. 1 is a structural view of a brush-less DC motor control device provided in an embodiment of the present invention;

FIG. 2 is a schematic view of a position signal, a phase current, a modulation signal and a reference time moment of a three-phase brush-less DC motor provided in an embodiment of the present invention;

FIG. 3 is a structural view of a rotating coordinate system of a three-phase brush-less DC motor provided in an embodiment of the present invention;

FIG. 4 shows a brush-less DC motor control system provided in an embodiment of the present invention;

FIG. 5 is a structural view of a control integrated circuit of a brush-less DC motor corresponding to FIG. 1;

FIG. 6 is a schematic view of a process where a triangular carrier wave modulates a modulation signal;

FIG. 7 is a flow chart of a control process of a brush-less DC motor corresponding to FIG. 1.

### DETAILED DESCRIPTION OF THE INVENTION

The technical solution of the present invention is described in further detail in conjunction with the attached drawings and embodiments.

A brush-less DC motor usually uses one or more position sensors to detect the position of a motor rotor, and outputs drive signals of each phase according to the rotor position and the modulation algorithm to form a rotary magnetic field and push the rotor to rotate. The windings of the brush-less motor presents inductance characteristics, so the phase current of the motor lags behind the applied drive voltage. In order to fulfill the aims of efficiency optimization and high-speed operation, it needs to apply a certain lead angle onto the drive voltage.

According to the present invention, a reference time moment is selected first; the direct axis current of the motor is calculated at the reference time moment; the phase of the drive voltage of a motor coil is automatically adjusted upon the relationship between the direct axis current and an expected target current; and then the self-adaptive control of the brush-less DC motor under the condition of different load characteristics is achieved, thus improving the performance, reliability and consistency of the brush-less DC motor and reducing difficulties in material management.

In the present application, the direct axis current is the sum of the current components of all phase currents of the motor on the direct axis in a rotating coordinate system which is synchronous to the rotor motor and takes the magnetic field direction as the direct axis and the direction vertical to the magnetic field direction as the quadrature axis.

A three-phase brush-less DC motor is used as an example below to further describe the control device provided in this embodiment.

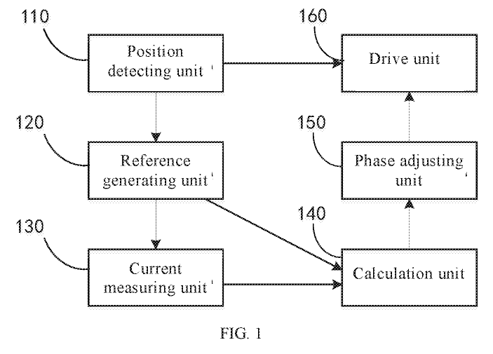

FIG. 1 is a structural view of a brush-less DC motor control device provided in an embodiment of the present invention. As shown in FIG. 1, the control device for the brush-less DC motor can include a position detecting unit 110, a reference generating unit 120, a current measuring unit 130, a calculation unit 140, a phase adjusting unit 150 and a drive unit 160.

The position detecting unit 110 detects the position of a motor rotor and acquires the corresponding position signal according to the position of the motor rotor.

Taking the three-phase brush-less DC motor as an example, the position detecting unit 110 can include three Hall components arrayed at a certain electric angle interval (for example 120 DEG). The Hall components detect the rotor position according to the magnetic field of the motor rotor and acquire the corresponding position signals of the rotor. The position signals are voltage signals.

It should be understood that, in the case of non-three-phrase brush-less DC motor, the position detecting unit 110 can include at least one Hall component.

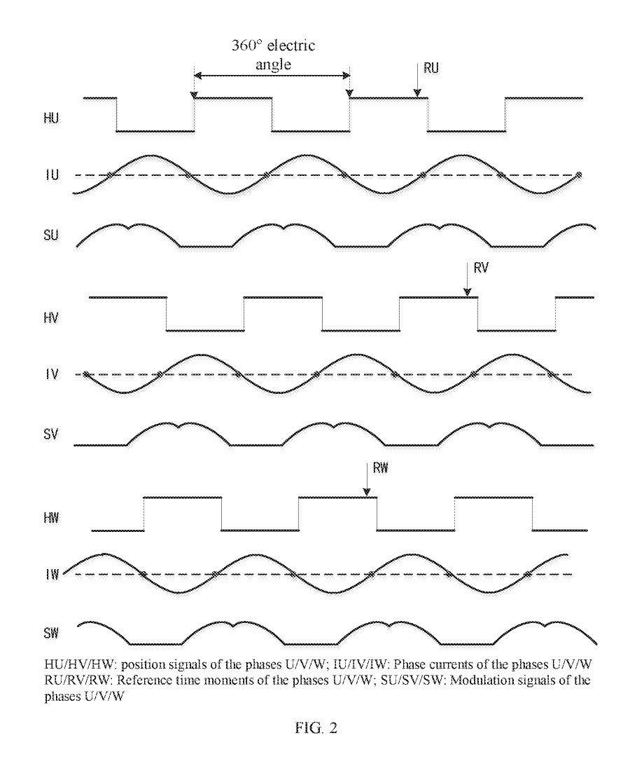

As shown in FIG. 2, HU, HV and HW are three-phase position signals; IU, IV and IW are respectively phase currents of three-phase coils U, V and W; SU, SV and SW are respectively modulation signals of the three-phase coils U, V and W, which means that the modulation signals SU, SV and SW are generated according to the three-phase position signals HU, UV and HW and certain algorithms.

The reference generating unit 120 is used for selecting a reference time moment according to the position signal of the motor rotor. Theoretically, any time moment during an electrical cycle can be selected as a reference time moment, and one or more reference time moments can be selected. During the selection of the reference time moment, calculation convenience, control accuracy, etc. can be taken into consideration. As shown in FIG. 2, RU, RV and RW are respectively reference time moments corresponding to the three-phase position signals HU, HV and HW.

The current measuring unit 130 is used for measuring the phase current of the motor and acquiring the phase current at the reference time according to the phase current of the motor.

Specifically, the current measuring unit 130 may measure the phase current in real time or intermittently. Correspondingly, the phase current at the reference time moment can be directly measured by the current measuring current 130 at the reference time moment, and can also be obtained through estimation of the previously measured value of the phase current. For example, when a current sensor is used, the phase current can be measured in real time. Or, when resistors connected in series to the coil are used to detect the phase current, the detection of the phase current is needed to be constantly related to the on or off of the corresponding power device, so the measuring time moment is not the reference time movement. In such circumstances, the phase current at the reference time moment is obtained through estimation.

The calculation unit 140 is used for calculating the direct axis current of the motor according to the reference time moment and the phase current at the reference time moment.

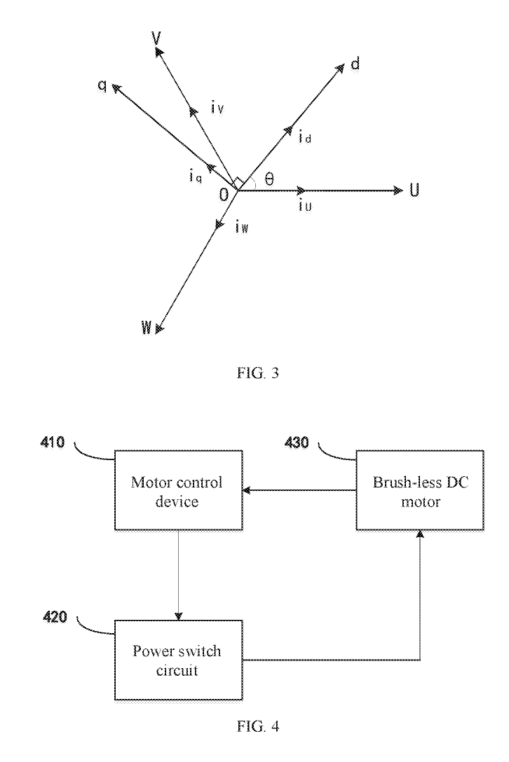

As shown in FIG. 3, in the rotating coordinate system which is synchronous to the rotor, the magnetic field direction is the direct axis (d axis), and the direction vertical to the magnetic field direction is the quadrature axis (q axis). In a static reference coordinate system, the three phase current directions are defined as axes, namely U axis, V axis and W axis, and the axes are spaced at a 120° electrical angle interval two by two. If the d axis is located at the position as shown in FIG. 3 at a certain reference time moment, then the direct current i_{d} is:

i_{d}=A_{MP}[i_{U} cos(θ)+i_{V} cos(θ−2/3π)+i_{W} cos(θ+2/3π)]

In the format, i_{U}, i_{V} and i_{W} are phase currents along the directions of the U axis, V axis and W axis in the static coordinate system which is formed by the three phase currents; A_{MP} is a normalization coefficient for converting the static coordinate system, formed by the three phase currents, into the rotating coordinate system which is synchronous to the motor rotor; 2/3π is the included angle between every two of the phase currents of the U axis, V axis and W axis; and θ is the included angle between the U axis and the direct axis.

The angle θ is the included angle between the d axis in the rotating coordinate system and the U axis in the static coordinate system at a certain reference time moment, which means that the angle θ is the correlation moment of the rotating coordinate system and static coordinate system at a certain reference time moment.

The reference generating unit 120 generates the reference time moment, and at each reference time moment, the rotating coordinate system and the static coordinate system form an included angle θ, which means that the reference time moment corresponds to the included angle θ one by one.

During an electrical cycle, the reference generating unit 120 can generate one or more reference time moments, which means that one or more angles θ exist during an electrical cycle.

It should be understood that, the sum of the phase currents of the three phases is zero, namely i_{U}+i_{V}+i_{W}=0, so when θ=2nπ, i_{d}=2/3A_{MP}i_{U}; when θ=(2n+1)π, i_{d}=−2/3A_{MP}i_{U}, wherein n is an integer. This means that, by selecting the reference time moment, the direct axis current can be obtained by calculating the phase current of a certain phase. In this way, the calculation of the direct axis current is simplified and the realization of greater control in time is aided.

Correspondingly when the reference time moment is selected in other special modes, the direct axis current i_{d} can also be obtained by only calculating i_{V} or i_{W}, for example θ=2nπ+2/3π.

The phase adjusting unit 150 is used for adjusting the phase of the drive voltage of the motor coil according to the difference value between the direct axis current of the motor and an expected target current.

Further, the phase of the drive voltage of each phase coil of the motor can be adjusted uniformly or separately. The adjustment mode depends on various factors including control policies, sensor installation deviation, magnetizing uniformity, and selection of the reference time moment.

In an example, as shown in FIG. 2, only the direct axis current at the reference time moment RU is calculated, and the phases of the modulation signals SU, SV and SW of the three phase coils U, V and W are uniformly adjusted according to the direct axis current at the moment RU; or, the corresponding direct axis currents at the reference time moments RU, RV and RW are calculated, and the phases of the modulation signals SU, SV and SW of the three phase coils U, V and W are adjusted according to the corresponding direct axis currents.

The drive unit 160 is used for outputting drive signals of each phase coil according to the position signal of the motor rotor and the drive voltage of the motor coil, wherein the drive signals output by the drive unit 160 are pulse width modulation signals, obtained by modulation of the modulation signals and carrier waves.

The drive unit 160 outputs the pulse width modulation signals, and applies the drive voltage to each phase coil of the motor through a power component (for example MOS (Metal Oxide Semiconductor) or IGBT (Insulated Gate Bipolar Transistor)). The phase currents IU, IV and IW of the three phase coils form a rotating magnetic field to push the motor rotor to rotate.

FIG. 4 shows a brush-less DC motor control system provided in an embodiment of the present invention. As shown in FIG. 4, the control system for the brush-less DC motor can include a brush-less DC motor control device 410, a power switch circuit 420 and a brush-less DC motor 430.

The brush-less DC motor control device 410 is used for executing the working procedures of all functional units in the above embodiments and outputting the drive signals.

The power switch circuit 420 is used for receiving the drive signals output by the brush-less DC motor control device 410 and outputting drive voltage. The power switch circuit 420 switches on or off the circuit of the control system according to the drive signals. The power switch circuit 420 can include a power component, for example MOS or IGBT.

The brush-less DC motor 430 includes a motor rotor, and can apply the drive voltage to the motor coils such that the currents generated in the coils generate the rotating magnetic field, to push the rotor to rotate.

FIG. 5 is a structural view of a control integrated circuit of a brush-less DC motor corresponding to FIG. 1. As shown in FIG. 5, the brush-less DC motor controlled integrated circuit can include a position detecting circuit 510, a reference generating circuit 520, a current measuring circuit 530, a calculation circuit 540, a phase adjusting circuit 550 and a drive circuit 560.

The position detecting circuit 510 detects the position of the motor rotor and acquires the position signal of the rotor according to the Hall signals generated by external Hall components.

The position detecting circuit 510 can include a Hall drive circuit 511 and a cyclic measuring circuit 512.

When external Hall components generate analogue signals, the Hall drive circuit 511 converts the analogue signals into digital signals; when the adopted Hall components are integrated with the drive circuit, the Hall drive circuit 511 is not necessary.

The cyclic measuring circuit 512 is used for acquiring the corresponding position signal (voltage signal) according to the position of the motor rotor. For example, the cyclic measuring circuit 512 can be a counter for counting the period where the Hall drive circuit 511 generates the digital signal.

The reference generating unit 520 is used for selecting a reference time moment according to the position signal of the rotor acquired by the position detecting circuit 510. For example, the reference generating circuit 520 can be a counter for selecting a reference time moment by counting according to the position signal.

The current measuring circuit 530 can include a signal amplifying circuit 531 and an analog-digital converter 532.

Optionally, the current measuring circuit 530 detects and acquires the phase current of the brush-less DC current through resistors first.

The signal amplifier 531 is used for amplifying the phase current. The analog-digital converter 532 is used for performing analog-digital conversion on the amplified current.

It should be noted that, the detection of the phase current is not in real time, but needs to be constantly related to the on or off of the corresponding power device, so the measuring time moment may be not the reference time movement. In such circumstances, the phase current at the reference time moment is obtained through estimation. The calculation process of the direct axis current is illustrated in FIG. 1 and therefore is not repeatedly described here.

The calculation unit 540 is an arithmetic unit (for example, multiplying unit), used for calculating the direct axis current of the motor according to the phase current at the reference time moment.

The phase adjusting unit 550 is used for adjusting the phase of the drive voltage of the motor coil according to the difference value between the direct axis current of the motor and an expected target current. Such adjustment can be implemented by adopting PID (Proportion Integration Differentiation) control.

The drive circuit 560 is used for outputting the drive signal according to the position signal of the motor rotor and the voltage phase adjusted by the phase adjusting circuit.

The drive circuit 560 can include a duty ratio control circuit 561, a modulation signal generating circuit 562, a triangular carrier wave generating circuit 563, a PWM generating circuit 564 and an electric level conversion circuit 565.

The duty ratio control circuit 561 is used for generating a control signal of the duty ratio for the pulse width modulation signal.

The modulation signal generating circuit 562 is used for generating the modulation signal according to the modulation algorithm and the control signal of the duty ratio.

The triangular carrier wave generating circuit 563 is used for generating a triangular carrier wave at a fixed frequency.

The PWM generating circuit 564 is used for generating the pulse width modulation signal by using the triangular carrier wave modulation signal.

The electric level conversion circuit 565 is used for converting the electric level of the pulse width modulation signal into a drive signal for controlling the on and off of the power component.

Optionally, the duty ratio control circuit 561 determines the duty ratio of the pulse width modulation signal through controlling amplitude of the modulation signal.

Optionally, the PWM generating circuit 564 is also used for sampling and comparing the triangular carrier wave and the modulation signal to acquire the corresponding pulse width modulation signal.

It needs to be noted that, the electric level conversion circuit 565 can be not incorporated into the drive circuit 560. In such circumstances, the pulse width modulation signal output by the drive circuit 560 may fail to directly control the on and off of the power component, so external electric level conversion circuit is needed to control the power component

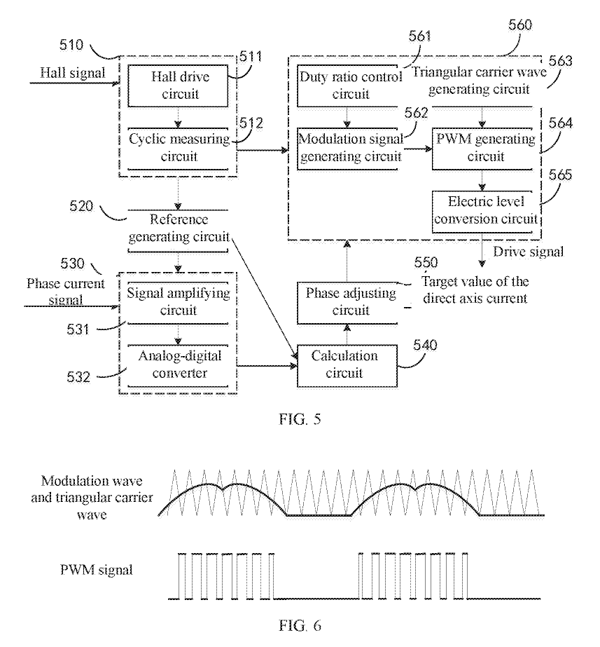

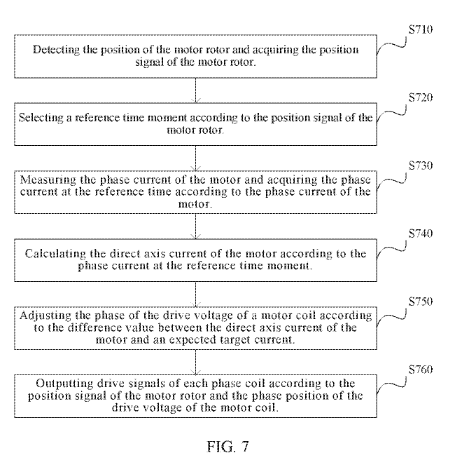

The process where the PWM generating circuit 564 uses the triangular carrier wave to modulate the modulation signal (or modulation wave) can be seen in FIG. 6. As shown in FIG. 6, a regular sampling rule is adopted to sample and compare the triangular carrier wave and the modulation function to acquire the corresponding PWM signal. The shape of the modulation signal is set by an algorithm, while the amplitude depends on the duty ratio control circuit 561. The duty ratio control circuit 561 determines the duty ratio of the PWM signal through controlling amplitude of the modulation signal. It should be understood that, the brush-less DC motor control system as shown in FIG. 4 may be integrated in a chip such that the chip has the functions of the brush-less DC motor control system.

FIG. 7 is a flow chart of a control process of a brush-less DC motor corresponding to claim 1. As shown in FIG. 6, the control process can include the following steps:

Step 710. Detecting the position of the motor rotor and acquiring the position signal of the motor rotor.

Step 720. Selecting a reference time moment according to the position signal of the motor rotor.

Step 730. Measuring the phase current of the motor and acquiring the phase current at the reference time according to the phase current of the motor.

Step 740. Calculating the direct axis current of the motor according to the phase current at the reference time moment.

Step 750. Adjusting the phase of the drive voltage of a motor coil according to the difference value between the direct axis current of the motor and an expected target current.

Step 760. Outputting drive signals of the motor coil according to the position signal of the motor rotor and phase of the drive voltage of the motor coil to push the motor rotor to rotate.

Optionally, the step of selecting the reference time moment according to the position signal of the motor rotor specifically includes selecting one or more reference time moments during an electrical cycle according to the position signal of the motor rotor.

Optionally, the step of acquiring the phase current at the reference time moment according to the phase current of the motor specifically includes measuring the phase current at the reference time moment according to the phase current of the motor to acquire the phase current at the reference time moment.

Optionally, the step of acquiring the phase current at the reference time moment according to the phase current of the motor specifically includes estimating the phase current at the reference moment according to the measured phase current of the motor during an electrical cycle to acquire the phase current at the reference time moment.

Optionally, the direct axis current i_{d} is expressed in a way of i_{d}=A_{MP}[i_{U} cos(θ)+i_{V} cos(θ−2/3π)+i_{W} cos(θ+2/3π)], wherein i_{d} is the current along the direction of the direct axis in the rotating coordinate system which is synchronous to the motor rotor, i_{U}, i_{V} and i_{W} are respectively phase currents along the directions of the U axis, V axis and W axis in a static coordinate system which is formed by three phase currents; A_{MP} is a normalization coefficient for converting the static coordinate system, formed by the three phase currents, into the rotating coordinate system which is synchronous to the motor rotor; 2/3π is the included angle between every two of the phase currents of the U axis, V axis and W axis; and θ is the included angle between the U axis and the direct axis at the reference time moment.

Optionally, when the motor is a multi-phase motor, the method also includes uniformly adjusting the phase of each phase coil or respectively adjusting the phase of each phase coil according to the difference value between the direct axis current of each phase coil and the corresponding expected target current.

Optionally, the drive signal of the motor coil is the pulse width modulation signal.

Optionally, repeat steps 710-760, and then the direct axis current at the reference time moment will approach the expected target current. Thus, the corresponding control objectives can be achieved.

It is needed to be noted that, the phase adjustment process is completed automatically, and does not depend on the characteristics of the motor and its loads, so the present invention has a higher adaptability.

The steps in the above embodiment can be implemented by various functional units as shown in FIG. 1, so the specific implementation processes of steps provided by the embodiment of the present invention are not repeatedly described here.

The steps of the method or algorithm described in the embodiment in the text can be implemented by hardware, a software module which is executed by a processor, or a combination of the two. Software commands can be composed of corresponding software modules. The software modules can be stored in a ROM (Random Access Memory), a flash memory, an EPROM (Erasable Programmable Read-Only Memory, an EEPROM (Electrically Erasable Programmable Read-Only Memory), a hard disc, an optical disc or memory media in any other forms known among those skilled in the art. An exemplary storage medium is coupled to the processor such that the processor can read information from the storage medium and write information into the storage medium. Of course, the storage medium can also be a constitutional part of the processor. Of course, the processor and the storage medium can also be individual components stored in the user equipment.

Those skilled in the art should conceive that, in one or more examples, the functions described in the present application can be conducted by hardware, software, firmware or any combinations thereof. When software and firmware are adopted, the functions can be memorized in a computer readable medium.

The objectives, technical solution and beneficial effects of the present application are described in further detail by using the above specific implementation. It should be understandable that the above embodiments are merely some specific implementation modes of the present invention and do not limit the protective scope of the present application. Any modifications, changes, etc. made on the basis of the technical solution of the present application should fall within the protective scope of the present application.

1. A brush-less DC motor control device, characterized in that the device comprises:
a position detecting unit, used for detecting the position of a motor rotor and acquiring a position signal of the motor rotor according to the position of the motor rotor;
a reference generating unit, used for selecting a reference time moment according to a position signal of the motor rotor;
a current measuring unit, used for measuring the phase current of the motor and acquiring a phase current at the reference time moment according to the phase current of the motor;
a calculation unit, used for calculating a direct axis current of the motor according to the phase current at the reference time moment;
a phase adjusting unit, used for adjusting a phase of the drive voltage of a motor coil according to a difference value between the direct axis current of the motor and an expected target current; and,
a drive unit, used for outputting drive signals of the motor coil according to the position signal of the motor rotor and the phase of the drive voltage of the motor coil to push the motor rotor to rotate.

2. The device according to claim 1, characterized in that the position detecting unit comprises one or more Hall components; the Hall components are mutually spaced at a certain electric angle interval;
and each of the Hall components detects the position of the motor rotor and acquires the corresponding position signal according to the position of the motor rotor.

3. The device according to claim 1, characterized in that the reference generating unit selects one or more reference time moments during an electrical cycle according to the position signal of the motor rotor.

4. The device according to claim 1, characterized in that the current measuring unit measures the phase current at the reference time moment according to the phase current of the motor to acquire the phase current of the reference time moment.

5. The device according to claim 1, wherein the current measuring unit estimates the phase current at the reference time moment according to the measured phase current of the motor during an electrical cycle to acquire the phase current at the reference time moment.

6. The device according to claim 1, characterized in that the direct axis current i_{d} is expressed below:
i_{d}=A_{MP}[i_{U} cos(θ)+i_{V} cos(θ−2/3π)+i_{W} cos(θ+2/3π)],
wherein i_{d} is the current along the direction of the direct axis in the rotating coordinate system which is synchronous to the motor rotor; i_{U}, i_{V} and i_{W} are respectively phase currents along the directions of the U axis, V axis and W axis in a static coordinate system which is formed by three phase currents; A_{MP} is a normalization coefficient for converting the static coordinate system formed by the three phase currents into the rotating coordinate system which is synchronous to the motor rotor; 2/3π is the included angle between every two of the phase currents of the U axis, V axis and W axis; and θ is the included angle between the U axis and the direct axis at the reference time moment.

7. The device according to claim 1, characterized in that when the motor is a multi-phase motor, the phase adjusting unit uniformly adjusts the phase of each phase coil or respectively adjusts the phase of each phase coil, according to the difference value between the direct axis current of each phase coil and a corresponding expected target current.

8. The device according to claim 1, wherein the drive signal of the drive motor coil output by the drive unit is a pulse width modulation signal.

9. A brush-less DC motor control system, characterized in that the system comprises:
the brush-less DC motor control device according to any one of claims 1-8, which outputs the drive signal of the motor coil;
a power switch circuit, comprising a power component, wherein the power component is controlled to turn on or off according to the drive signal output by the brush-less DC motor control device to output the drive voltage to the motor coil; and,
a brush-less DC motor, comprising a motor rotor, wherein the motor rotor is driven to rotate according to the drive voltage.

10. A brush-less DC motor control method, characterized in that the method comprises steps:
detecting a position of the motor rotor and acquiring a position signal of the motor rotor;
selecting a reference time moment according to the position signal of the motor rotor;
measuring a phase current of the motor and acquiring a phase current at the reference time moment according to the phase current of the motor;
calculating a direct axis current of the motor according to the phase current at the reference time moment;
adjusting a phase of a drive voltage of a motor coil according to a difference value between the direct axis current of the motor and an expected target current;
and, outputting drive signals of the motor coil according to the position signal of the motor rotor and the phase of the drive voltage of the motor coil to push the motor rotor to rotate.

11. The method according to claim 10, characterized in that the step of selecting a reference time moment according to the position signal of the motor rotor specifically comprises: selecting one or more reference time moments during an electrical cycle according to the position signal of the motor rotor.

12. The method according to claim 10, characterized in that the step of selecting a phase current at the reference time moment according to the phase current of the motor specifically comprises:
measuring the phase current at the reference time moment according to the phase current of the motor to acquire the phase current at the reference time moment.

13. The method according to claim 10, characterized in that the step of selecting a phase current at the reference time moment according to the phase current of the motor specifically comprises:
estimating the phase current at the reference time moment according to the measured value of the phase current of the motor during an electrical cycle to acquire the phase current of the reference time moment.

14. The method according to claim 10, characterized in that the direct axis current i_{d} is expressed below:
i_{d}=A_{MP}[i_{U} cos(θ)+i_{V} cos(θ−2/3π)+i_{W} cos(θ+2/3π)],
wherein i_{d} is the current along the direction of the direct axis in the rotating coordinate system which is synchronous to the motor rotor; i_{U}, i_{V} and i_{W} are respectively phase currents along the directions of the U axis, V axis and W axis in a static coordinate system which is formed by three phase currents; A_{MP} is a normalization coefficient for converting the static coordinate system, formed by the three phase currents, into the rotating coordinate system which is synchronous to the motor rotor; 2/3π is the included angle between every two of the phase currents of the U axis, V axis and W axis; and θ is the included angle between the U axis and the direct axis at the reference time moment.

15. The method according to claim 10, characterized in that when the motor is a multi-phase motor, the method also comprises:
uniformly adjusting the phase of each phase coil or respectively adjusting the phase of each phase coil, according to the difference value between the direct axis current of each phase coil and a corresponding expected target current.

16. The method according to claim 10, characterized in that, the drive signal of the motor coil is a pulse width modulation signal.
